(19) United States
(12) Patent Application Publication
(10) Pub. No.: US 2006/0161411 A1
(43) Pub. Date: Jul. 20, 2006

(54) Computer program and method for determination of electronic circuit card durability under exposure mechanical shock loading

(76) Inventor: John E. Starr, Plymouth, MN (US)

Correspondence Address: JOHN E STARR, 3450 FERNBROOK LANE NORTH, PLYMOUTH, MN, 55447, US

(21) Appl. No.: 10/972,682

(22) Filed: Oct. 25, 2004

(51) Int. Cl. G01L 5/00

(52) U.S. Cl. 703/14; 702/42

(57) ABSTRACT

An application program and method for determining the strength of electronic products exposed to mechanical shock, including application program steps of (i) describing the mechanical configuration of the electronic product; (ii) describing the stock response; (iii) calculating natural response modes of the circuit card; (iv) calculating stress functions for each component, each response mode; (v) using stress functions to determine modal component stresses at peak response; (vi) removing computer calculation error by comparing the stresses for all components to expectations; (vii) expectations numerically defined by performing equivalent analyses on test experience.

### BACKGROUND

1. Field of the Invention

The field of the invention relates to use of computer methods for validating the operational durability of an electronic circuit card after shock loading based upon physics-of-failure analysis of modal responses and stress limit correlation of laboratory shock tests.

2. Discussion of Prior Art

During its design life, an electronic product can be exposed to a wide variety of vibration and shock environments. Shock environments include impact loading due to drop or handling as well as explosive shock that might be experienced by military electronics in a combat environment. Testing programs to understand mechanical shock have been historically supported by detailed analysis using finite element programs. Electronic systems are very complex structures with characteristics that make accurate predictive analysis very difficult.

Prior art methods of determining the shock durability of electronic designs have included the use of extensive test programs, sometimes supported by detailed finite element analysis. When failure occurs under mechanical shock loading, the failure is a local stress fracture of one or more components of the system. Testing for information on shock capability of electronic components is rarely performed. Testing is usually limited to defining capabilities at the assembly level. Due to variations in so many contributing factors, including material properties and dimensional tolerances, testing programs to fully understand product capabilities must be very extensive. Since a test only provides pass or fail information, testing must be extensive since it must be capable of finding all of the possible failures of a system. Since parts typically vary significantly in the parameters that effect failure, the test procedure must include variations that accommodate the expected variations of critical parts. Historically, test programs have often failed to provide information critical to understanding the shock capability of the product.

Application of conventional detailed finite element analysis can aid in the knowledge gained in these testing programs. But detailed analysis is also very time consuming and expensive. There are wide variations in properties (material and dimensional) that affect component strength. Often, detailed analysis is thought to be accurate beyond its actual capability for the variations typical in electronic systems. Detailed analysis for stress of mechanical shock loading of electronic systems with predictive methods has very high error rates.

Testing with or without detailed finite element analysis support can be ended based on budget considerations without an adequate understanding of the product's real-life capabilities.

Prior art includes:

‘Test only’ methods

‘Detailed analysis only’ methods

Combined test/analysis methods

‘Test only’ methods suffer from lack of detailed information on all parts and don't define the risk for all possible failures. Drop tests are representative of the most common type of mechanical shock test for electronics. Drop tests are of means of defining a level of required ruggedness. With the increased use of electronics systems in rugged environments, as in military electronics in battlefields, there is a greater need to define mechanical shock capabilities. Prior art in the field of high mechanical shock of electronics is very limited, but since failures due to flexural response under mechanical shock will tend to occur at the same locations that fail under vibration, prior art in the vibration of electronics are the closest prior art references. References 1 and 2, U.S. Pat. Nos. 5,675,098 and 5,744,975, are examples where test only methods might be used. These test methods can be enhanced when supported by detailed analysis. U.S. Pat. Nos. 5,847,259 and 5,965,816 specifically include analysis of test results, but these analyses emphasize the statistical analysis of results of tests on many samples, not detailed analysis of the product being tested to understand the failure at the root cause level. U.S. Pat. No. 6,035,715 is an example of using test methods in a trial and error basis, using tests to cause repeated failures to increase capabilities by redesign to eliminate the weakest links.

Analysis only methods suffer from high error that is inherent in the parts used in electronic systems, but do provide information for all parts. However, the accuracy of the analysis for each part is unknown and creating analysis with an adequate margin to cover all error may be too conservative of a method in order to meet design requirements.

Combined test and analysis methods are the best means of obtaining an understanding of the electronic system, but prior art analysis methods were extremely expensive and the analysis methods required expertise not available at all organizations involved in development of electronic systems. U.S. Pat. No. 6,678,627 is an example of combined test and analysis methods as applied to fatigue failure under vibration. Fatigue failure occurs as a result repeated load cycles and failure occurs as a result of accumulation of damage. U.S. Pat. No. 6,678,627 does not address mechanical shock failure. Shock failure occurs under high stress above the material yield limits.

In order to develop a reliable product using prior art methods, designs had to be developed with margins capable of extapolating test/analysis results to cover configuration variations and inherent modeling error.

### OBJECTS AND ADVANTAGES

The primary objective of the computer program and method presented is to understand the effects of mechanical shock on electronic products. Electronic products are exposed to mechanical shock, drop, handling shocks, impulses, etc. as part of normal life cycle conditions. This program and method addresses the modal response portion of stresses. Due to the stress peaks occurring at different instants in time, the individual modal responses can be considered individually. Contributions from other modes at the time of the peak, at the location of the highest stress can be expected to be small. However, the contributions of all modes can be evaluated.

An additional objective is to determine a numerical definition of limit stresses at component level based on the physics-of-failure and limit stress equivalence such that the stress generated in any test condition can be compared to all other combinations of conditions. A method of removing computational error associated with the complex field of shock capability of electronics is used so that the associated analysis yields product understanding. Methods provide a detailed numerical definition of stress at component part level that benefits from all previous experience, not just from designs of similar configuration or shock excitation level. Comparison of component detailed stress determines if a component is at risk of failure for a mechanical shock. This method uses the benefits of the circuit card's natural shock and vibration modal isolation that protects most of the component parts.

The prior art method of ‘test only’ is very expensive and suffers from a lack of detailed information. The prior art methods using ‘analysis only’ require a high level of expertise, are very expensive, and lack accuracy due to high error inherent in electronic system designs. Prior art for combined test and analysis methods requires a high level of expertise primarily due to the mathematical modeling in the analysis. The combined methods are very expensive and the prior art analysis methods suffer from a high level of inaccuracy.

The present invention analysis methods are greatly simplified, with lower requirements on level of expertise. The methods provide the capability of performing analysis in support of test programs with removal of error typical in analysis of electronic systems. The methods are efficient, resulting in lower costs of the combined test and analysis programs.

The one sure method of defining capabilities is testing a product to failure. This defines a product's limits, but detailed analysis is required to provide a numerical definition to the product at point-of-failure level. The present invention provides product understanding efficiently and accurately.

### SUMMARY

The present invention relates to a computer program and method for validating the operational durability of an electronic product based upon physics-of-failure analysis and limit stress correlation of mechanical shock tests.

The application program and method for determining the stresses experienced during mechanical shock testing of an electronic product, includes the application program steps of

(i) describing the configuration of the electronic product including layout with card geometry, component location with pin attachment points and by entering structural properties and support conditions;

(ii) describing the mechanical shock loading as a defined peak response, as a Shock Response Spectrum, as a shock time history, or other means;

(iii) a program means for calculating natural response modes of the circuit card including natural frequency and mode shape;

(iv) a program means for calculating the stress functions for each component and response mode, including stresses from inertial loading and forced modal displacement;

(v) a program means for calculating the stresses for each component by factoring component stress functions for the expected shock peak responses for critical response modes;

(vi) removing computer calculation error by comparing the peak stresses for all components to the expectations of capability based on component type and component quality;

(vii) a program means for defining the expectations of components by detailed analysis of actual tests to failure.

### DRAWINGS

Other objects, features and advantages of the invention will be apparent from a study of the written descriptions and drawings in which:

FIG. 1 illustrates a flow diagram for a computer program for use in design or determination of capabilities in accordance with the present invention.

### DETAILED DESCRIPTION

When electronic systems are exposed to shock or vibration, the “structure” responds in natural modes. Each natural mode is characterized by a frequency and a bending mode shape in which the structure can have sustained vibration due to a natural balance of mass and stiffness. Stresses developed under shock or vibration are higher at these natural response modes and can result in structural failure of the hardware. An application program and method provides a means of numerically defining the structural capability under mechanical shock. The method removes the error associated with detailed analysis of electronic systems.

The stress distribution in the structure is defined by the modal displacement shape that occurs under response to shock or vibration excitation. Stress factors can be calculated for each component for each mode shape, each factor being a peak stress per unit peak displacement. The stress for each component is a multiple of the stress factor times the peak displacement experienced under shock. The peak displacement can be determined by test or by various analytical methods.

One example of analytical means is using a Shock Response Spectrum (SRS) to define the shock. The SRS is a plot of peak response versus natural frequency of responding “single degree of freedom” systems (each system at a different natural frequency). The expected response for a system is determined by reading the response at the natural frequency of the system of interest. The SRS can be defined in displacement, velocity or acceleration terms.

Circuit cards are not single degree of freedom systems. They are complex structures with distributed mass. As a complex system, the response of the distributed mass structure is governed by the Modal Participation Factor (MPF, equ. 1) and the generalized mass (equ. 2). The peak response for the distributed mass system, would be a multiple of the “single degree of freedom” SRS values. This multiple is defined by “Factor” in equ. 3. The terms Mᵢ and Φᵢ are the iₜₕ Mass and Displacement of the iₜₕ mass for the mode shape being considered. The summation includes all the mass increments of the structure.
The Modal Participation Factor:

$$MPF = {\sum }_{i} {Φ}_{i} {M}_{i} \qquad Equ . 1$$

The Generalized Mass:

$$SRS Factor = \frac{{Φ}_{max} {\sum }_{i} {Φ}_{i} {M}_{i}}{{\sum }_{i} {Φ}_{i}^{2} {M}_{i}} \qquad Equ . 3$$

Factor on SRS for a Distributed Mass System:

$$Generalized Mass = {\sum }_{i} {Φ}_{i}^{2} {M}_{i} \qquad Equ . 2$$

S(f) is the stress response function which is established for each critical location for each natural response mode. S(f) represents the relationship between the response acceleration to the local stress. S(f) is determined in the computer program by performing a detailed finite element stress analysis of each component including inertial loads and forced modal displacements. In any CAE tool use, the accuracy of the prediction of stress level depends on many factors—including the accuracy of numerous material property values and also level of detail in the model required to accurately describe the complex stress distribution. In electronic systems, material properties such as elastic modulus and thermal coefficient of expansion, which are critical to accurate calculation of stress levels, have values that vary widely. Component parts also have large geometric tolerances. Any prediction of life capabilities must allow for the range of values for parameters critical to life. These parameters include geometric features and material properties, multi-axis loading behavior, residual stress, and more.

The one sure method of defining capabilities is testing a product to failure. This defines a product's limits, but detailed analysis is required to establish a numerical definition of the product at point-of-failure level. The computer program defines the Limit Stress/Expectations ratio as the means to obtain these values. The electronic product is then understood at component level.

When predictive calculations are compared to calculations of actual tests to failure, the total level of error is established without a need for defining all the contributing factors. Comparing stresses for any test to stresses experienced at failures (known as expectations), defines the risk of failure of any part.

The stresses calculated for components that have been tested to actual failure define the expectations for components of similar design. A similar design component is one that has a similar means of transferring component structural stiffness to the circuit card assembly. Components with like leadwire types and like leadwire pitches can be considered to be similar. Since the analysis model is designed to properly represent the transfer of loads from the assembly to the component, calculated stresses will compensate for component configuration differences. Stresses above thresholds will imply a risk of failure. The comparisons to calculated thresholds are made to compensate for the unknowns typical of electronics systems, since detailed work to perform exact calculations is cost prohibitive. Using this ratio removes the inherent error that results from all the contributions of the details of the analysis.

Using a standard component for analysis is just an extension in the use of the stress ratio. The calculated stress at failure includes a factor on stress due to error and unknowns and a factor due to differences in the actual component and the standard component. The accuracy of this method is maximized if standard component parameters can be selected to properly represent the dominant stress at the point of failure. The use of standard components also allows a numerical definition of solder quality.

For the Limit Stress/Expectations method, stress analysis is performed for all components using standards. The standard component used must include details capable of representing the internal load distribution within the component. For components that are sensitive to modal bending, this includes lead attachment details at ends necessary to create the forces necessary to bend the component to match the mode shape. The ‘standard’ stress for all components is compared to expectations of capabilities for the component type analyzed. The expectations of a component are numerically defined by performing analysis on components that have been tested to failure using the standard component configuration in the analysis model. All test experience can be analyzed, defining a distribution of capabilities. The lower range of the distribution of failures, excluding defective items, defines the stress limits. When a component stress falls far below minimum expectations for that component type, that component is a low risk component When stress is near or above these minimums, the risk of failure increases. Understanding mechanical shock capability of the circuit card has two parts:

1) knowing the stress limits (based on the standard) for all components,

2) knowing the capability of components relative to expectations (weak, ‘expectations’ or ruggedized).

When a component stress exceeds expectations, capabilities should be verified.

Most components are stress dominated by curvature, rather than acceleration; therefore, test measurements provided by accelerometers provide little insight to a design's capabilities. The method translates test measurements into numerical values meaningful to component shock strength.

The described method is effective for electronic systems due to the effects of the modal isolation. Only a small portion of the design is at risk of failure and this approach efficiently defines risk.

When components are tested to failure, it is also desirable to calculate stresses for these components using all known parameters in order to better understand the capability and the reasons for the strength differences between this component and the standard. The computer program includes capability to evaluate components with parameters representative of standards or of actual design configuration.

### OPERATION OF INVENTION

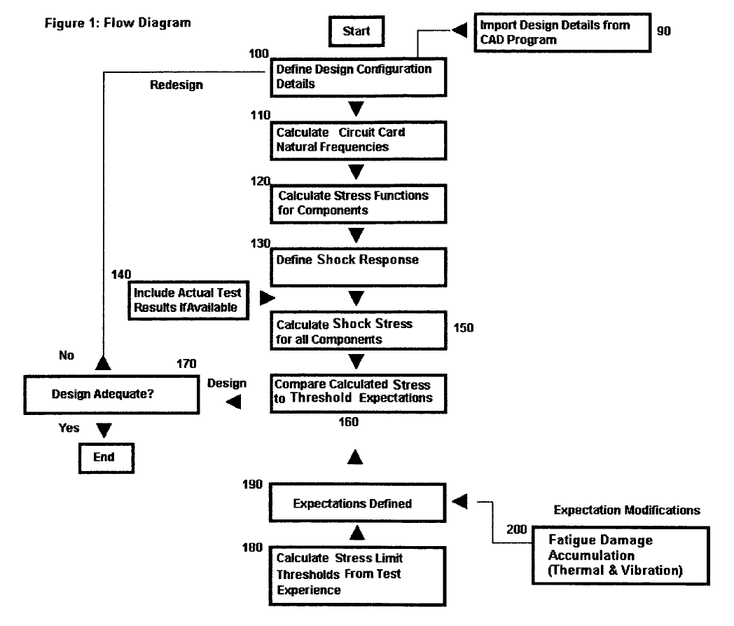

A logic flow diagram for implementing the method in accordance with the present invention on a computer is illustrated in FIG. 1.

A method in accordance with the present invention may be implemented on a general purpose computer. A computer program receives data describing the configuration of the system being analyzed, illustrated generally as 100 in FIG. 1. The data received includes information necessary for performing a modal analysis. This includes dimensional details and material properties. Support method must also be defined. Some of this data may be extracted from CAD data files 90. CAD program files contain layout information such as component names and pin connection locations. An example CAD program is Mentor Graphics Board Station, Mentor Graphics Corp, Wilsonville, Oreg. USA. Computer analysis, 110, of the configuration data results in calculation of the circuit card structural natural frequencies and corresponding mode shapes. Items 110 through 120 could otherwise be accomplished with a general purpose finite element analysis computer program. Based on the displacement mode shapes and the natural frequencies, local inertial loading values can be determined for all components. Structural models of each component analyze the local mode shapes and combine the forced displacement with the inertial forces to determine internal loading associated with the forced modal shapes. The stresses calculated from mode shape and inertial loading combine to define the component stress functions 120. The stress functions developed are peak component leadwire stress per 100 Gs of peak response at each natural response frequency. Component models include configuration details necessary to represent component internal loading distributions. This includes body size and leadwire locations.

The mechanical shock associated with the circuit card is defined 130. Peak shock response can be defined by test results or by defining the applied shock analytically. The applied shock can be defined by a time history (displacement, velocity or acceleration as a function of time). Shock can also be defined as a Shock Response Spectrum (SRS), which is a plot of peak responses expected for single degree of freedom systems to the time history of the shock represented by the SRS. Any means can be used to describe the expected peak response of the circuit card in its mode shape, since it is the mode shape peak response that defines stresses experienced. Stress calculations are performed using the stress functions 120 for all defined shocks 130. Using the stress functions 120 and the peak responses, the stress for each component can be determined. For the case of a shock defined by a SRS, the peak modal response can be determined by Equation 3. Since computer analysis in a predictive mode is high in error, a means of test correlation is used for error removal. Response stress is calculated using measured or predicted response 150. Similar analysis is performed on actual tests-to-failure or other conditions of experience to establish a numerical definition of expectations of component capabilities (180-190). Calculations are also performed on the test experience with the best understanding of values for dimensional and material properties, and with a finite element mathematical model used to represent the circuit card. Stress results from these analyses are used to compare to analysis results from the newly designed configurations. Calculation of a ratio of the results (analysis of new to analysis of test) removes error common to both analyses. In order to maximize the accuracy of the definition of the expectations of capability, actual test data, 140, can be used to analyze the system as tested. Comparison of computer analysis stress results to expectations, 160, defines the design adequacy and determines risk levels for all components. For the case of system design, 170, the stresses are compared to stress experienced that has caused failures in the past or to designs of adequate margin to quantify design margin.

The numerical definition of expectations for components is created by performing equivalent analyses of tests of components used in other designs that were life tested, 180-190. The lowest level of calculated stress obtained for components that have failed in tests defines the minimum expectations. When the stress calculated for a component analyzed for a design condition exceeds this minimum, it is considered to be at risk of failure. These comparisons are made using “standard models”. Comparison using “standard models” is an efficient analysis method as well as a means of removal of material property and other computer modeling errors, thereby providing an understanding of the products exposure to shock at root cause of failure level. If no failure data exists, the stresses can be compared to similar products that have had adequate design margins to determine if there are any components that might be considered at risk.

When parts of a design are found to be at risk of failure in this process, the product can be modified to eliminate the root cause of failure. The analysis procedure is repeated on the redesign to determine the change in capability. This virtual qualification of the product performs analysis on designs that are not built and tested, repeats steps 100-170 until an adequate design margin exists.

The ability to survive mechanical shock can be affected by the circuit card's previously accumulated fatigue damage from vibration and cyclic thermal loading. Performing shock tests on circuit cards that have had previous fatigue damage can determine the reduced stress thresholds that would result in component failure, step 200.

### OTHER REFERENCES

1. Hobbs, G. K. “Highly Accelerated Life Tests—HALT”, Hobbs Engineering Corporation, Westminster, Colo. 1990
2. Hobbs, G. K. “Highly Accelerated Stress-Screen—HASS”, Hobbs Engineering Corporation, Westminster, Colo. Apr. 14, 1990
   U.S. Class: 702/119
   field of search 73/1.01,662,808,866

### CONCLUSIONS, RAMIFICATIONS AND SCOPE

The primary objective of the present invention is to understand the effects of mechanical shock on electronic products. Electronic products are exposed to mechanical shock as part of normal life cycle conditions. However, mechanical shock of electronic systems is very complex and test and/or analysis programs have been very expensive.

The “test only” method, tests without supporting analysis fail to provide understanding of stress limits for all components. The “analysis only” method, analyses without test results are at risk due to undefined error level in mathematical modeling. In the current invention, the means of incorporating test results uses the best contribution of two methods for efficient and thorough understanding of product capabilities. Actual accelerometer response measurements are entered into the program input data set. These measurements are analyzed to determine the peak response for a more accurate definition of stresses experienced.

There has always been a hidden disadvantage to “testing only” programs. Test programs only provide hard definition of capability when a failure occurs. Parts near failure provide no hard data. Due to the large expected scatter in capabilities, this may hide a problem that could be critical to the reliability of the product during its projected life. Adding efficient and effective analysis to the test greatly reduces the risk of undiscovered areas of questionable reliability.

The program and methods of this invention are developed for efficient understanding of mechanical shock of electronic systems.

While the best mode of the method has been described in detail, one skilled in this art will be capable of numerous variations, modifications and adaptations without departing from the spirit and scope of the present invention. It should be understood that the present invention is not limited to the processes, embodiments or examples contained herein, but are limited only by the scope of the following claims.

I claim:

1. An application program and method for determining the stresses experienced during mechanical shock testing of an electronic product which includes the application program steps of
(i) describing the configuration of the electronic product;
(ii) describing the mechanical shock exposure;
(iii) a program means for calculating natural response modes of the circuit card;
(iv) a program means for calculating the stress functions for each component and response mode;
(v) a program means for calculating the shock response stress of each component;
(vi) removing computer calculation error by comparing the stresses for all components to the expectations of capability based on component type and component quality;

2. The application program for stock response stress calculation as described in claim 1, further comprising the step of:
(vii) a program means for entering actual test response levels for a numerically accurate definition of expectations.

3. The application program for stock response stress calculation as described in claim 1, further comprising the step of:
(viii) a program means for defining the expectations of components through analysis of actual shock tests of circuits cards, with and without failures.

4. The application program for stock response stress calculation as described in claim 1, further comprising the step of:
(ix) analysis of redesigned product to eliminate the root cause of failures observed in original design.

5. The application program for stock response stress calculation as described in claim 1, further comprising the step of:
(x) a program means for calculating effects of accumulated fatigue damage from vibration and thermal cycling history on the circuit card's ability to survive mechanical shock.
